(19) United States
(12) Patent Application Publication
(10) Pub. No.: US 2009/0061951 A1
(43) Pub. Date: Mar. 5, 2009

(54) HANDS-FREE ELECTRONIC DEVICE AND METHOD FOR THE OPERATION OF A HANDS-FREE ELECTRONIC DEVICE

(75) Inventors: Markus Giese, Olpe (DE); Jan Hille, Ludenscheid (DE); Christoph Schillo, Boblingen (DE); Gero Schumacher, Weil der Stadt (DE)

Correspondence Address: BURR & BROWN, PO BOX 7068, SYRACUSE, NY, 13261-7068, US

(73) Assignee: Peiker Acustic GmbH & Co. KG, Friedrichsdorf (DE)

(21) Appl. No.: 12/187,634

(22) Filed: Aug. 7, 2008

Related U.S. Application Data
(63) Continuation of application No. PCT/DE2007/000404, filed on Mar. 5, 2007.

(30) Foreign Application Priority Data
Mar. 8, 2006 (DE) 10 2006 011 121.4

(51) Int. Cl. H04M 1/00

(52) U.S. Cl. 455/569.2

(57) ABSTRACT

A hands-free electronic device for a vehicle in which the hands-free electronic device is connected to a cell phone so that incoming and/or outgoing communication links can be established by the hands-free electronic device via the cell phone. The hands-free electronic device generates a call number list based on the existence of a call number in the directory of the cell phone and the frequency of use of the call number.

### CROSS REFERENCE TO RELATED APPLICATIONS

This application is a continuation of International Application No. PCT/DE2007/000404 having an international filing date of Mar. 5, 2007, which designated the United States, and claims the benefit under 35 USC §119(a)-(d) of German Application No. 10 2006 011 121.4 having a filing date of Mar. 8, 2006, the entireties of which are incorporated herein by reference.

### FIELD OF THE INVENTION

The invention relates to a hands-free electronic device and method for the operation of a hands-free electronic device.

### BACKGROUND OF THE INVENTION

In hands-free electronic devices that work in conjunction with a cell phone, the problem is that, when conventional data exchange profiles such as the so-called HANDSFREE profile, PHONEBOOK ACCESS profile or the so-called SIM ACCESS profile are used in the cell phone, these have access, at the most, to call number lists with call numbers which are stored on the SIM card. Access to call number lists which are stored in an internal directory of a cell phone, is not possible, if just for security reasons. When using a cell phone in a vehicle together with a hands-free electronic device, there is thus no call number list available to the user from the cell phone that can be used via one of the interfaces of the hands-free electronic device, for example, touch screen, display or keypad. Furthermore, the group of persons called by telephone from the vehicle differs as a rule from the group of persons called by telephone from outside the vehicle. To this extent, a call number list existing in the cell phone is not necessarily optimally set up.

### SUMMARY OF THE INVENTION

The present invention is based on the object of developing a hands-free electronic device and a method for the operation of a hands-free electronic device which enables the user to be provided with a call number list which can be utilized via the hands-free electronic device or its interfaces, respectively.

The hands-free electronic device according to the invention for a vehicle comprises at least one memory in which in each case at least one call number or a reference to a storage location of the call numbers located outside the hands-free electronic device is collected for incoming and/or outgoing communication links, wherein a processor of the hands-free electronic device generates from the call numbers of the collected communication links, a call number list in which the call numbers of incoming and/or outgoing communication links are sorted in accordance with their frequency of use or in accordance with additional connection data collected for each of the respective communication link. Using such a hands-free device, it is possible to generate, independent of the expanded capabilities of the hands-free electronic device for accessing the cell phone, a call number list having a structure which maps to at least one telephone characteristic with regard to incoming and/or outgoing communication links. The core of the invention is thus a hands-free electronic device which generates a call number list based on an evaluation of call numbers. Such call management for a hands-free device offers a comfortable possibility for operating the cell phone in the vehicle since communication from the vehicle in most cases takes place with a very small circle of subscribers. The hands-free electronic device according to the present invention controls the connected cell phone and is thus capable of independently setting up calls with numbers from its call number list and accepting calls. This is made possible by a separate call number list created independent of the SIM card of the cell phone, the call number list containing the subscribers which, for example, are called frequently and regularly. Such a call number list cannot be manipulated by the user and reflects the user's dialing behavior. Dialing repetitions which are not successfully connected on a communication link do not influence the call number list.

In the present invention, the call number list is understood to include at least a list of call numbers and preferably names associated with call numbers, which is sorted by means of at least one sorting criterion. The call number list is also called a top list or list.

In the present invention, the hands-free electronic device further comprises electronics in the hands-free device which take over the coordination of all components connected to the hands-free electronic device such as, for example, loudspeaker, microphone, display, voice output, voice input and multimedia facility or audio facility of the vehicle.

The present invention collects exclusively the call numbers of communication links which take place and checks the call numbers with the call numbers stored in a directory of the cell phone by means of the hands-free electronic device. Such a check ensures that the hands-free electronic device collects only call numbers that the user has documented as important by means of an entry in the directory of his cell phone.

According to the present invention, the hands-free electronic device also reads and stores, separate from the call number belonging to the communication link, in the memory of the hands-free device, at least temporarily, the features stored for this call number in the directory of the cell phone. It is thus possible to automatically allocate to the call numbers additional features since these can be taken from the entries in the directory of the cell phone.

The present invention also collects, in the memory of the hands-free device, connection data such as call time and/or call duration for a communication link. As a result, it is possible to generate in the hands-free electronic device, for example, time-of-day-dependent or day-of-week-dependent call number lists.

The present invention also provides functionality to display the generated call number list generated by the hands-free electronic device on a display, such as a vehicle display, allocated to the hands-free electronic device. As a result, a particularly simple overview of a number of entries is possible.

The present invention can also administer and permanently store call number lists from a number of cell phones in the memory of the hands-free electronic device. This provides for the utilization of a hands-free electronic device by a number of users, wherein each user identifies himself by means of his cell phone.

According to the present invention, the hands-free electronic device identifies the connected cell phone by means of its call number and/or its serial number. As a result, an unambiguous correlation of stored call number lists with a cell phone is possible.

The present invention also enables the user to link one of the call number lists generated in the hands-free electronic device to another cell phone. This provides for transfer of call number lists already in existence, when changing to a new cell phone or when changing to another call number, for example.

The present invention can also connect the hands-free electronic device to the cell phone via a radio link. As a result, connecting the cell phone is particularly simple.

In the alternative, the present invention connects the hands-free electronic device to the cell phone via a cable. This is advantageous if a particularly manipulation-proof connection is desired between the cell phone and the hands-free electronic device.

Furthermore, the present invention provides for the data exchange between the cell phone and the hands-free electronic device using any one of the so-called HANDSFREE profile, the so-called PHONEBOOK ACCESS profile or of the so-called SIM ACCESS profile. These profiles allow at least one access to the directory stored on the SIM card.

Finally, the invention provides a method for the operation of a hands-free electronic device in which the hands-free electronic device, with each incoming or outgoing communication link, checks in a directory of the cell phone whether there is an entry in the directory for the call number on the communication links that exist or existed, and stores this call number or a reference to a storage location of the call number located outside the hands-free electronic device, if there is an existing entry, in memory, wherein the hands-free electronic device generates a call number list from the entries stored for a communication link in its memory in which the entries in the call number list are sorted in accordance with their frequency and/or in accordance with additional connection data collected for the respective communication link. Using such a method, it is possible to generate, independent of extended capabilities of the hands-free electronic device to access the cell phone, a call number list having a structure that maps to at least one telephone characteristic with regard to incoming and/or outgoing communication links. The core of the method is a hands-free electronic device independently generating a call number list, that is based on the existence of the call number in the directory of the cell phone and an evaluation of the call numbers of the collected communication links.

In addition, the present invention provides the capability to combine or match to one another, respectively, with each updating or generating of the call number list of the hands-free electronic device, the call number list entries from the memory of the hands-free electronic device and the entries from the directory of the cell phone. This makes it possible to update the call number list of the hands-free electronic device with the current directory of the cell phone, with minimum expenditure.

### BRIEF DESCRIPTION OF THE DRAWINGS

Further details of the invention are described by means of diagrammatically represented exemplary embodiments in the drawing, in which:

FIG. 1 shows a first variant of an embodiment of a hands-free electronic device according to the invention;

FIG. 2 shows a second variant of an embodiment of a hands-free electronic device according to the invention;

FIG. 3 shows a representation of a first menu content of a display;

FIG. 4 shows a representation of a second menu content of a display; and

FIG. 5 shows a flow chart which describes an operating mode of a hands-free electronic device according to the invention.

### DETAILED DESCRIPTION OF THE INVENTION

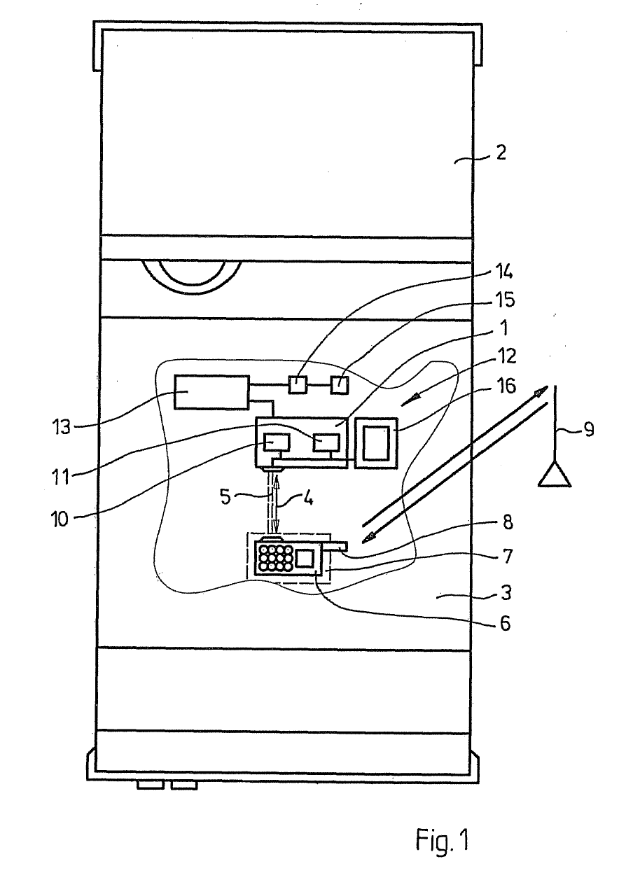

FIG. 1 shows a first embodiment of a hands-free electronic device 1 according to the present invention. The hands-free electronic device 1 is arranged in a vehicle 2 which is depicted with a roof 3 cut open. The hands-free electronic device 1 is connected to a cell phone 6 via a radio link 4 or via a cable 5, which are shown in the alterative. The cell phone 6 is arranged in a holder 7 and is connected by a radio frequency (RF) link via an antenna 8 to a telephone network which is symbolized by a mobile radio antenna 9. The hands-free electronic device 1 comprises a memory 10 and a processor 11. To implement a hands-free device 12, an audio system 13 which comprises loudspeaker 14 and a microphone 15, and a display 16 are also connected to the hands-free electronic device 1, in addition to the cell phone 6. On the display 16, a list or call number list can be displayed. The memory 10 of the hands-free electronic device 1 collects in each case at least one call number for incoming and/or outgoing communication links, the processor 11 of the hands-free electronic device 1 generating from call numbers of the collected communications links the call number list which can be displayed on the display 16. In generating the call number list, the stored call numbers are sorted by the processor 11 in accordance with their frequency and/or in accordance with connection data collected in addition to the respective communication link. Thus, for example, the call number, which has been dialed most frequently, is at the top of a call number list of outgoing communication links. In a call number list of incoming communication links, for example, the call number from which calls have been received most frequently is at the top of a call number list of incoming communication links.

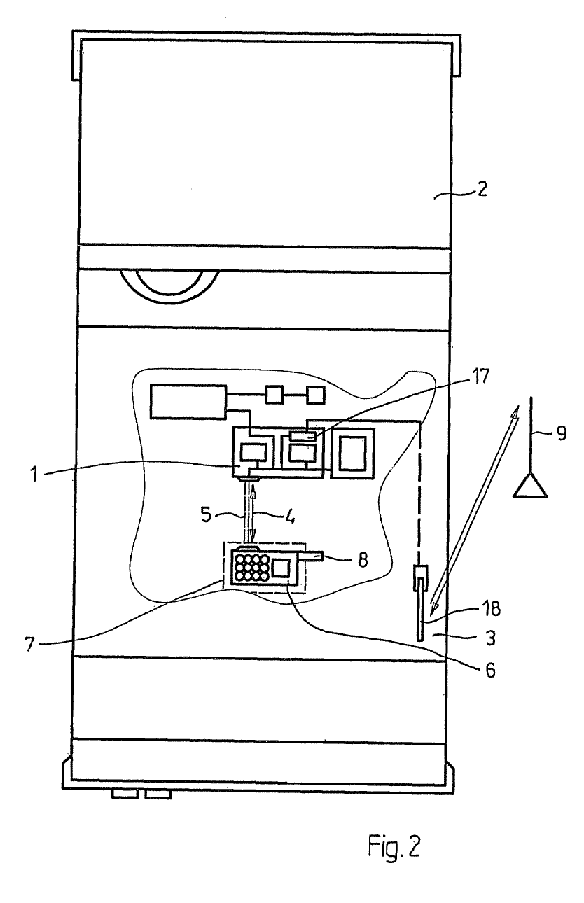

FIG. 2 shows a second variant of an embodiment of a hands-free electronic device 1 according to the invention. The hands-free electronic device 1 is again arranged in a vehicle 2 which is depicted with a roof 3 cut open. The hands-free electronic device 1 is connected to a cell phone 6 via a radio link 4 or via a cable 5, which are shown in the alternative. The cell phone 6 is arranged in a holder 7 and is not in radio communication with a telephone network which is symbolized by a mobile radio antenna 9 via an antenna 8. According to the so-called SIM ACCESS profile, a radio link to the telephone network is set up via a telephone mobile 17 which transmits and receives via an external antenna 18 of the vehicle 2. With respect to the remaining components and with respect to the operating mode, reference is made to the description for FIG. 1.

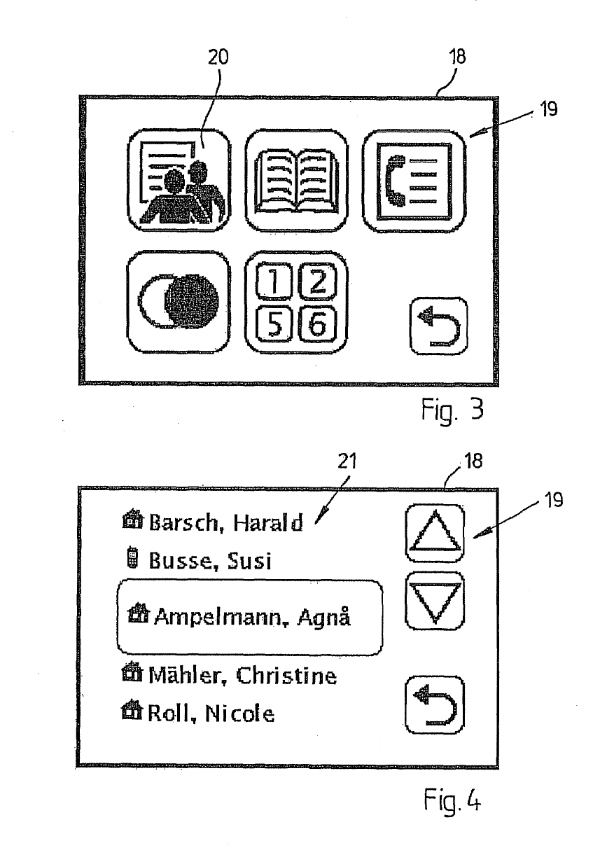

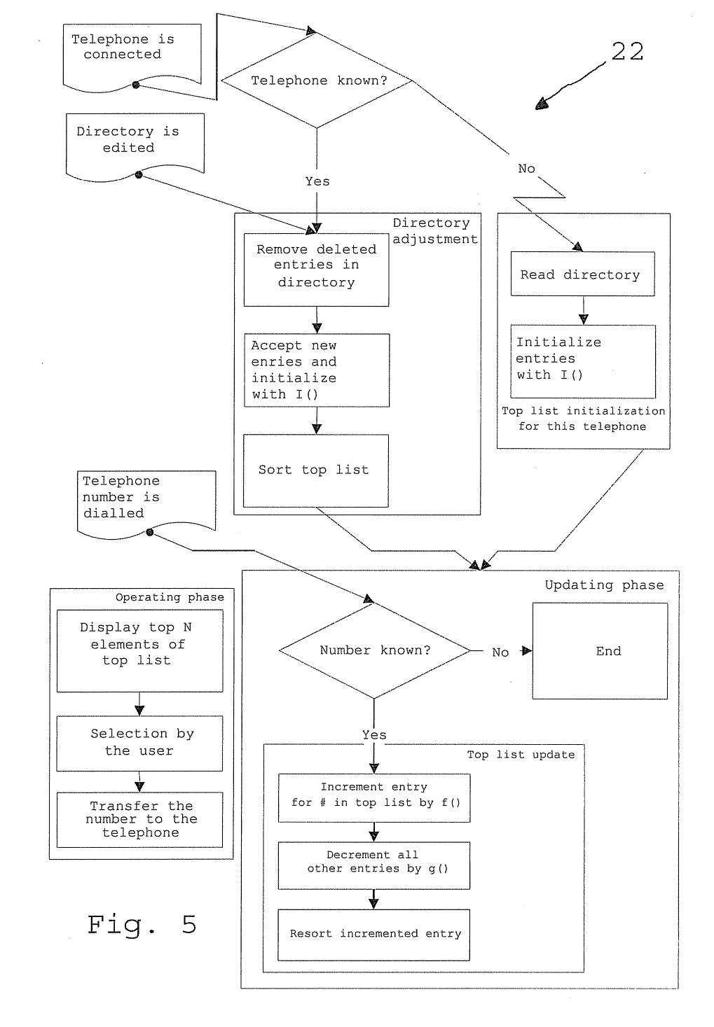

FIG. 3 shows a first level of display content 19 on a display 18 which is connected to a hands-free device, not shown here. The display content 19 comprises 6 symbols, wherein a call number list which, for example, comprises those call numbers or call parties which have been frequently called from the vehicle and are also collected in a directory of the cell phone, the call number list being sorted in accordance with the frequency of successful dialing of the call party, can be selected via a symbol 20 arranged at the top left. Selecting symbol 20 displays a call number list 21 as a second level of a display content 19 on a display 18, as shown in FIG. 4. The call number list 21 is also designated by the term “top list”. The display 18 is constructed, for example, as touch-sensitive display device in order to enable an entry of the displayed selection list to be manually selected.

FIG. 5 shows a flow chart 22 which describes an operating mode of a hands-free electronic device according to the present invention.

When connected to a cell phone, an evaluation list of call numbers from the cell phone directory is administered in the hands-free electronic device. The hands-free electronic device recognizes the connected cell phone and can store call number lists for a single cell phone or a number of cell phones. When the cell phone is switched on or when the cell phone is changed, the call number list is updated. Numbers no longer contained in the cell phone directory are removed and new numbers are accepted with an initialization factor (i). If a number is dialed that is contained in the directory of the connected cell phone, its weighting factor increases by a factor (f). On the basis of this weighting factor (f), the directory of the cell phone can be sorted and the top N entries are displayed to the user as a so-called top list, for example, on a display associated with the hands-free electronic device, for further selection. If a number of entries have the same weighting, recent entries are given preference on the call number list. Furthermore, numbers which have not been used for a long time are devaluated via a forget function (g) so that the top list always represents the current status of the preferred call parties. Each of the numbers present for an entry in the directory, for example private number, office number or cell phone number, are separately evaluated and dealt with by the hands-free electronic device. The top list which is displayed as a selection list on the display is marked with the names associated with the entries and with a symbol for its category. The top list does not correspond to the sequential call number list of the dialed numbers as implemented in conventional cell phones but is an automatically generated selection of the dialing behavior of the user in the vehicle.

In one operating mode of the present invention, the top N entries of the top list are displayed if a display is available and, a call number on the top list can be transferred directly to the cell phone by paging in the call number list and selecting the call number as a number to be dialed or, if the SIM ACCESS profile is used, to the cell phone module.

In a dynamic updating mode of the present invention, a dialed number which has successfully connected on a communication link is compared, independent of whether it has already been pulled up from the directory, by redialing or by user selection from one of the call lists or from the top list, to the call number list stored for the respective cell phone and if the number exists in the directory of the cell phone, the associated counter (f) is correspondingly incremented. If the call number is unknown, the call number is ignored. It is assumed that preferred call numbers exist in the directory of the cell phone. To reduce the memory requirement in the hands-free electronic device and optimally adapt the call number list generated in the hands-free electronic device to the directory of the cell phone, the associated names are not stored in the call number list but read out of the directory. In the memory of the hands-free electronic device, only a reference to a storage location, located outside the hands-free electronic device, of the call number is stored, the storage location of the call number, located outside the hands-free electronic device, being, for example, the SIM card contained in the cell phone.

If call numbers are removed from the directory of the cell phone, the corresponding counters for the call numbers are also deleted and new numbers are correspondingly accepted.

The invention is not restricted to the exemplary embodiments shown or described. Instead, it comprises developments of the invention in the context of the patent claims. In particular, the present invention collects, in the memory of the hands-free electronic device for each call number or each reference to a storage location of a call number, the frequency of its use by means of a counter.

### LIST OF REFERENCE DESIGNATIONS

1 Hands-free electronic device
2 Vehicle
3 Roof of 2
4 Radio link between 1 and 6
5 Cable between 1 and 6
6 Cell phone
7 Holder for 6
8 Antenna of 6
9 Nobile radio antenna
10 Memory in 1
11 Processor in 1
12 Hands-free device
13 Audio system
14 Loudspeaker
15 Microphone
16 Display
17 Telephone module
18 External antenna of 2
19 Display content of 16
20 Symbol
21 Call number list, list, top list
22 Flow chart

We claim:

1. A hands-free electronic device for a vehicle, wherein the hands-free electronic device is connected to a cell phone in which at least one of incoming and outgoing communication links can be established by the hands-free electronic device via the cell phone, wherein the hands-free electronic device comprises at least one memory in which at least one of a call number and a reference to a storage location of the call number located outside the hands-free electronic device is collected for communication links, wherein a processor of the hands-free electronic device generates, from call numbers of the collected communication links, a call number list in which the call numbers of the communication links are sorted by at least one of frequency of use and connection data collected for the communication links.

2. The hands-free electronic device as claimed in claim 1, wherein the hands-free electronic device collects exclusively call numbers of communication links which take place from the vehicle and are stored in a directory of the cell phone.

3. The hands-free electronic device as claimed in claim 1, wherein the hands-free device reads and stores in the at least one memory, at least temporarily, and separate from the call number of the communication link, one or more features which are stored for the call number in the directory of the cell phone.

4. The hands-free electronic device as claimed in claim 1, wherein the at least one memory of the hands-free device also collects connection data for a communication link.

5. The hands-free electronic device as claimed in claim 1, wherein a display for displaying the generated call number list is allocated to the hands-free electronic device.

6. The hands-free electronic device as claimed in claim 1, wherein the call number lists of at least two cell phones can be administered and permanently stored in the at least one memory of the hands-free electronic device.

7. The hands-free electronic device as claimed in claim 1, wherein the hands-free electronic device identifies the cell phone connected to the hands-free electronic device by at least one of call number and serial number.

8. The hands-free electronic device as claimed in claim 1, wherein at least one of the call number lists generated by the hands-free electronic device can be linked to another cell phone.

9. The hands-free electronic device as claimed in claim 1, wherein the hands-free electronic device is connected to the cell phone via a radio link.

10. The hands-free electronic device as claimed in claim 1, wherein the hands-free electronic device is connected to the cell phone via a cable.

11. The hands-free electronic device as claimed in claim 1, wherein the hands-free electronic device exchanges data with the cell phone via a HANDSFREE profile.

12. The hands-free electronic device as claimed in claim 1, wherein the hands-free device exchanges data with the cell phone via a PHONEBOOK ACCESS profile.

13. The hands-free electronic device as claimed in claim 1, wherein the hands-free device exchanges data with the cell phone via a SIM ACCESS profile.

14. The hands-free electronic device as claimed in claim 1, wherein the radio link between the hands-free electronic device and the cell phone is a Bluetooth standard connection.

15. A method for the operation of a hands-free electronic device which is connected to a cell phone, wherein the hands-free electronic device compares each communication link to the directory of the cell phone to determine whether there is an existing entry in the cell phone directory, and when an entry exists in the cell phone directory, stores at least one of the call number and a reference to a storage location of the call number that is located outside the hands-free electronic device, in the at least one memory, wherein the hands-free electronic device generates a call number list from the entries stored in the at least one memory in which the entries are sorted by at least one of frequency of use and connection data collected for the communication links.

16. The method as claimed in claim 15, wherein the entries stored in the at least one memory of the hands-free electronic device and the entries from the directory of the cell phone are at least one of compared, combined and matched to generate or update the call number list.
